(19) United States
(12) Patent Application Publication
(10) Pub. No.: US 2015/0279191 A1
(43) Pub. Date: Oct. 1, 2015

(54) SYSTEM AND APPLICATION FOR MEDICAL REPORTING

(71) Applicant: Shelley S. Bath, Niagara Falls, NY (US)

(72) Inventor: Shelley S. Bath, Niagara Falls, NY (US)

(21) Appl. No.: 14/231,725

(22) Filed: Mar. 31, 2014

(51) Int. Cl. G08B 21/18; G08B 5/36; G08B 21/02

(52) U.S. Cl. CPC G08B 21/182; G08B 21/02; G08B 5/36

(57) ABSTRACT

A system and method for reporting and certifying receipt of alerts may include receiving a notification of an alert concerning an event, from an event initiator. A list of events may be provided to at least one user. Access to the specific alert from the event may be provided to the at least one user. Receipt of the specific alert from the event may be certified by the at least one user. Certification of receipt including date and time stamp may be recorded. The method may be used for reporting critical results to physicians, and for the physician to certify they have received the results.

### BACKGROUND OF THE INVENTION

The present invention relates to medical reporting and, more particularly, to a system and application for medical reporting.

Currently, there are often delays in vital information relayed within the medical field. This in turn sometimes causes delay in treatment. For example, a primary physician may take several days before getting an abnormal radiology result such as pneumonia, an abnormal lab value, biopsy result or the like. Furthermore, sometimes these results fall through the cracks and important diagnoses are missed altogether. There is often too much delay on one end or the other with sending out and receiving results.

Current methods include: pagers such as with medical residents; EMR, where a primary physician looks at a screen, sees abnormal results and calls patients; letters where the results are placed in a physician's box, and calls directly to the primary physician are used. Often in this situation, the primary physician is hard to find, such as when they are away from their desk, with a patient, or there is trouble locating their phone number.

As can be seen, there is a need for an application that may instantly send results to primary physicians without the hassle of on one end trying to reach a provider, and on the other hand also certifies that the primary physician is now aware of the results.

### SUMMARY OF THE INVENTION

In one aspect of the present invention, a method for reporting and certifying receipt of alerts comprises: receiving a notification of an alert concerning an event, from an event initiator; providing a list of events to at least one user; providing access to the specific alert from the event to the at least one user; certifying receipt of specific alert from the event, from the at least one user; and recording certification of receipt including date and time stamp.

In another aspect of the present invention, a system for reporting and certifying receipt of alerts comprises: a computer having a user interface; a program product comprising machine-readable program code for causing, when executed, the computer to perform the following process steps: receiving a notification of an alert concerning an event, from an event initiator; providing a list of events to at least one user; providing access to the specific alert from the event to the at least one user; certifying receipt of specific alert from the event, from the at least one user; and recording certification of receipt including date and time stamp.

These and other features, aspects and advantages of the present invention will become better understood with reference to the following drawings, description and claims.

### BRIEF DESCRIPTION OF THE DRAWINGS

FIG. 1 is a block diagram of an exemplary embodiment of the present invention;

FIG. 2 is a plan view of an exemplary embodiment of the present invention, having a mobile device showing a critical alert;

FIG. 3 is a plan view of an exemplary embodiment of the present invention, having a mobile device showing stored studies; and

FIG. 4 is a plan view of an exemplary embodiment of the present invention, having a mobile device showing specific study data.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and method for reporting and certifying receipt of alerts that may include receiving a notification of an alert concerning an event, from an event initiator. A list of events may be provided to at least one user. Access to the specific alert from the event may be provided to the at least one user. Receipt of the specific alert from the event may be certified by the at least one user. Certification of receipt including date and time stamp may be recorded. The method may be used for reporting critical results to physicians, and for the physician to certify they have received the results in an appropriately timing manner.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

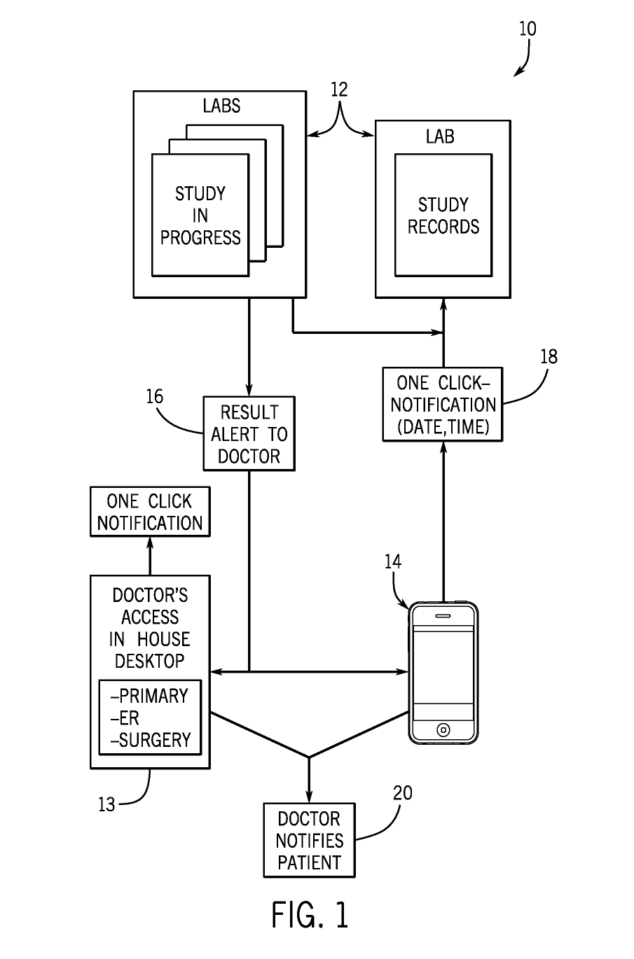

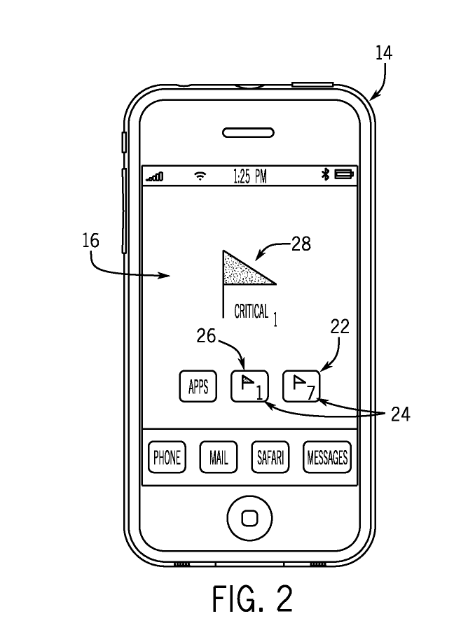

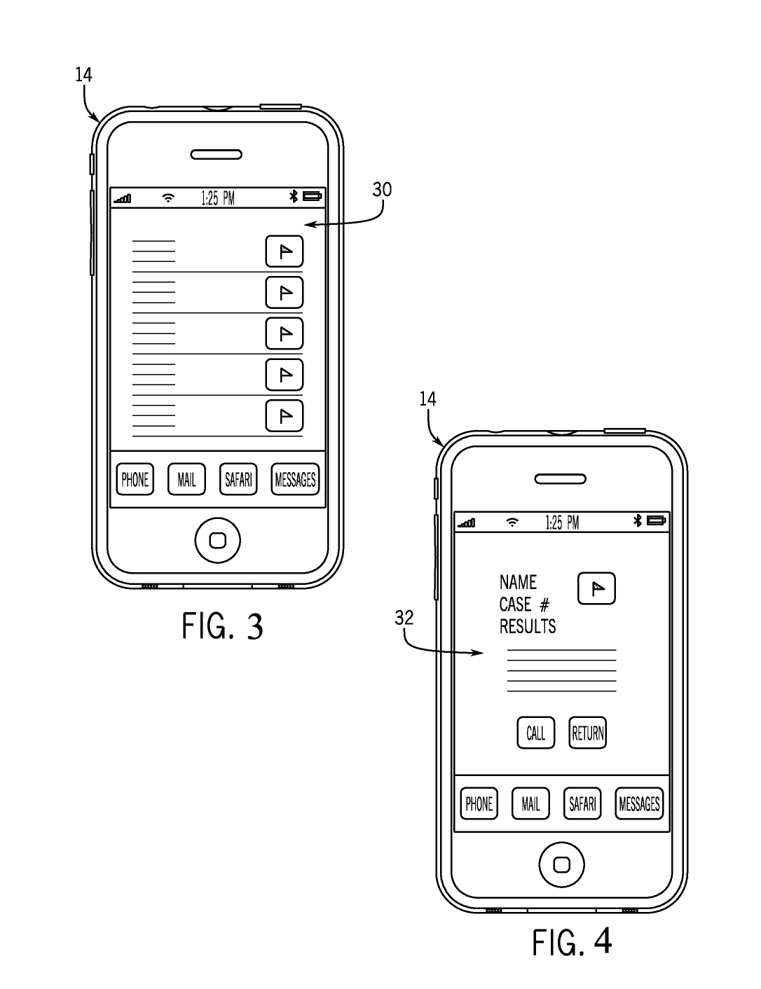

As is illustrated in FIGS. 1 through 4, the present invention 10 may include a method for reporting and certifying receipt of alerts. An event initiator 12, such as a medical lab or the like, may produce an event, such as a lab study or the like. The event may produce an alert, such as a set of medical results from the lab study. The event initiator 12 may determine the critical level of the alert. The critical level may be critical/non-critical, or various degrees within the critical/non-critical extremes. At least one user may have access to a computer, such as a mobile device 14. The at least one user may be a physician or the like. The at least one user may be notified of an alert 16. The notification may be through an application on the mobile device 14 or the like. In certain embodiments, a main screen 16 of an application may show the alert 28. The main screen 16 may also show at least one alert icon, such as a critical alert icon 26, a non-critical alert icon 22, or the like. In certain embodiments, the alert icon may also provide the number of alerts 24 available for that particular critical level alert. The application may also provide a list of events 30. The application may provide access to the details of a specific alert 32, such as results from a specific medical test or the like. Once the at least one user may access and review the details of the specific alert 32, the at least one user may certify their receipt of the specific alert 18 by clicking on an icon or the like. The certification of the receipt may be recorded, and may include a date and time stamp. In certain embodiments, the physician may also contact a patient directly 20 once they have reviewed the medical results of the lab study or the like.

The at least one user, such as the physician, provider or the like, may have their information added to the application through the information given on a referral or from within a database for a community, healthcare system or the like. In certain embodiments, a radiologist may receive an x-ray and there are signs of pneumonia. The radiologist, or event initiator, may click on a yellow flag to be sent to the provider. In certain embodiments, there may be options for the event initiator to text, or scroll to a built in template with actual results of pneumonia within the application. The provider may be notified of the alert 16 and view the results via the application on the mobile device 14. The provider may then click acknowledgement, which may initial a certification of receipt.

In certain embodiments the critical alert icon 26 may be a colored flag, such as red or the like. In certain embodiments, the non-critical alert icon 22 may be a colored flag, such as yellow or the like. The non-critical alert icon 22 may be for results such as pneumonia or the like, while critical alert icons 26 may be for occurrences such as internal bleeding or the like, which may need immediate attention.

A method of using the present invention may include the following. Often, and especially overnight, an emergency room physician may interpret an x-ray that they have ordered. At first glance, they may miss incidental things such as a tumor and the like. A radiologist may come in the morning and make an official interpretation of the x-ray. If there is a positive finding, the application may be used to notify the emergency room. The personnel in the emergency room may be able to go over the reads from the radiologist, through the application, to see if they have missed anything, instead of going through all their findings. The emergency room personnel may be able to open the application and see the notification of alerts by a plurality of colored flags, such as yellow for concerned results, and red for critical, or the like, and use the application as a checking system. In certain embodiments the results may be sent to an in house desktop computer as well, where the at least one user may provide one-click certification/notification of receipt of the details of the specific alert.

In certain embodiments, the system may be used by administration and the like to notify a broad range of staff of meeting and the like, which can then be confirmed with receipt of acknowledgement. In certain embodiments, the system may be used within an academic environment to send out test results to students. In certain embodiments, mechanics may be the event initiator 12, and may use the system to notify customers that their automobile is ready for pickup. Restaurants may check with a patron if they are close by or running late for a reservation.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for reporting and certifying receipt of alerts comprising:
receiving a notification of an alert concerning an event, from an event initiator;
providing a list of events to at least one user;
providing access to the specific alert from the event to the at least one user;
certifying receipt of specific alert from the event, from the at least one user; and
recording certification of receipt including date and time stamp.

2. The method of claim 1, wherein the event is a lab study.

3. The method of claim 2, wherein the alert refers to a set of medical results from the lab study.

4. The method of claim 3, further comprising the step of the at least one user notifying a patient of the set of medical results from the lab study.

5. The method of claim 1, wherein the alert is at least one colored flag.

6. The method of claim 5, wherein the at least one colored flag represents the critical level of the alert.

7. A system for reporting and certifying receipt of alerts comprising:
a computer having a user interface;
a program product comprising machine-readable program code for causing, when executed, the computer to perform the following process steps:
receiving a notification of an alert concerning an event, from an event initiator;
providing a list of events to at least one user;
providing access to the specific alert from the event to the at least one user;
certifying receipt of specific alert from the event, from the at least one user; and
recording certification of receipt including date and time stamp.

8. The system of claim 7, wherein the event is a lab study.

9. The system of claim 8, wherein the alert refers to a set of medical results from the lab study.

10. The system of claim 9, further comprising the step of the at least one user notifying a patient of the set of medical results from the lab study.

11. The system of claim 7, wherein the alert is at least one colored flag.

12. The system of claim 11, wherein the at least one colored flag represents the critical level of the alert.
